(19) United States
(12) Patent Application Publication
(10) Pub. No.: US 2008/0090220 A1
(43) Pub. Date: Apr. 17, 2008

(54) MODULAR VIRTUAL LEARNING SYSTEM AND METHOD

(76) Inventors: Vincent Freeman, Indianapolis, IN (US); Greg Wilson, Indianapolis, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/846,331

(22) Filed: Aug. 28, 2007

Related U.S. Application Data
(60) Provisional application No. 60/953,063, filed on Jul. 31, 2007.
(60) Provisional application No. 60/823,739, filed on Aug. 28, 2006.

(51) Int. Cl. G09B 7/00; H04N 7/18; H04N 5/222

(52) U.S. Cl. 434/324; 348/61; 348/722; 348/E07.084; 348/E05.022

(57) ABSTRACT

A multimedia reproduction system comprises a computing subsystem operably connected to and controlling one or more of video, audio, and olfactory subsystems. The system accepts user input and adapts a multimedia presentation in response thereto. The subsystems are easily separable and configured in carrying cases that protect them during transport. The subsystems easily connect (physically and electronically) to each other upon delivery to form a system that presents 3-D, high definition video, surround-sound audio, and even scents from local and/or remote sources.

### CROSS-REFERENCE TO RELATED APPLICATIONS

This application claims priority to U.S. Provisional Patent Application No. 60/823,739 filed Aug. 28, 2006, and to U.S. Provisional Patent Application No. 60/953,063 filed Jul. 31, 2007, the disclosures of which are hereby incorporated by reference.

### FIELD

The disclosed technology relates generally to systems and methods for sending, receiving, and displaying multimedia information.

### SUMMARY

The following description is not in any way to limit, define or otherwise establish the scope of legal protection. In general terms, the disclosed technology relates to a transportable system for reading/receiving, controlling, and projecting high definition and/or stereoscopic multimedia educational content. Another embodiment displays multiple video and audio streams onto a unified display.

Further objects, embodiments, forms, benefits, aspects, features and advantages of the disclosed technology may be obtained from the description, drawings, and claims provided herein.

### BRIEF DESCRIPTION OF THE DRAWINGS

FIG. 1 is a perspective view of a multimedia presentation system according to one embodiment.

FIG. 2 is a perspective view of the embodiment of FIG. 1 as configured for transport.

FIG. 3 is a perspective view of a polarizing filter in position in front of one of the projectors in the embodiment of FIG. 1.

FIG. 4 is a block diagram of a multimedia presentation system according to another embodiment.

FIG. 5 is a perspective view of a multimedia presentation according to still another embodiment.

FIG. 6 is a block diagram of a multimedia presentation according to yet another embodiment.

### DESCRIPTION

For the purposes of promoting an understanding of the principles of the disclosed technology and presenting its currently understood best mode of operation, reference will now be made to the embodiments illustrated in the drawings and specific language will be used to describe the same. It will nevertheless be understood that no limitation of the scope of the disclosed technology is thereby intended, with such alterations and further modifications in the illustrated device and such further applications of the principles of the disclosed technology as illustrated therein being contemplated as would normally occur to one skilled in the art to which the disclosed technology relates.

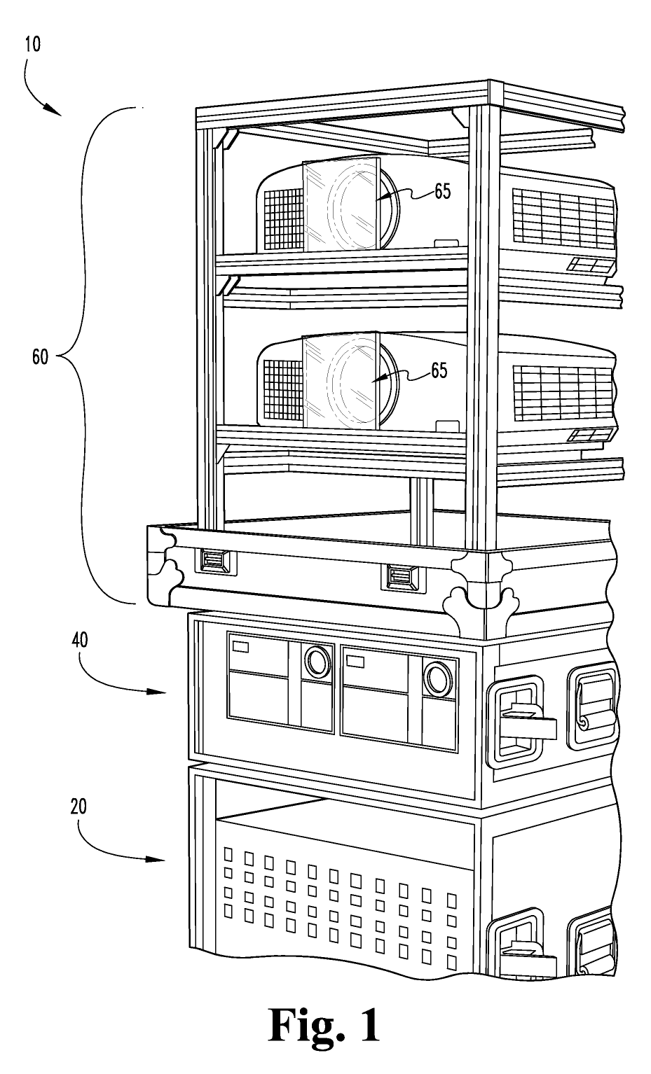

As illustrated in FIG. 1, one embodiment provides a system 10 comprising a computing subsystem 20, an audio subsystem 40, and a projection or display subsystem 60, with a controller, viewer feedback devices, and wireless headphones. In this embodiment, the computing subsystem 20 includes a GVS90004U 4-CPU G5 Quad-Core computer with 4 GB of RAM, a Quadra FX-4500 512 MB video card, a GeForce 6600 video card, four SATA II hard drives, a RAID controller, and a power strip to serve as a hub for power distribution into the system. The audio subsystem 40 in this embodiment includes an Anchor AN1000X powered 50 W speaker, an Anchor AN1001X companion speaker, and a power strip for distribution of electrical power to the audio subsystem. Optional additional components include a surround-sound amplifier and corresponding additional speakers, as well as a transmitter for sending one or more audio tracks wirelessly to appropriately tuned headphones so that listeners with headphones can receive audio that is different from the primary track played by the speakers (if any).

In this exemplary embodiment, the display subsystem 60 includes two Mitsubishi WD2000 3000-lumen DLP projectors 64, an extruded aluminum framework holding two 5-inch square polarizing filters 65, and a Xenarc 1020TSV 10.2″ touch screen controller. An optional transmitter for keypad interaction (as will be discussed below) may be housed in the display unit as well. One suitable screen for receiving the projected image is a 4.5′×8′ Silverglo screen.

In some embodiments, the computing subsystem 20 and/or other subsystems also includes optical media readers (for CD audio, CD-ROMs, DVDs and the like). In some of these and other embodiments, the computing subsystem 20 (or other subsystem) includes one or more network adapters for transmitting and receiving data to and from network-based resources.

Regardless of the source, the system can play preloaded or network-accessible multimedia content and run traditional computer software applications. An auxiliary display (not shown) in various embodiments and situations displays either the video content from one or both projectors or separate material, such as a control user interface. Content is displayed in monophonic, stereophonic, or “surround sound” audio with mono- or stereoscopic (3D) video. In another embodiment, the system also produces scents according to a scents track (either stored locally or retrieved via a data network) as is known in various forms in the art.

Some variations of the system include wireless remote input units. Some of these embodiments are adapted for use in educational settings, so that answers to comprehension questions, preference information, and the like can be collected by the system from each participant accurately, precisely, and in real time. In other examples, multimedia presentations are programmed automatically to adapt to input from multiple users via the keypads, such as for choosing a path or action in a simulated adventure or exploration, reviewing or re-presenting content that was not comprehended by a certain proportion or number of participants based on their feedback or quiz results, accelerating presentation of content that a group has apparently mastered, and the like.

Other embodiments include wireless headsets for delivery of different audio tracks to one or more particular participants. For example, DVD video content might be accompanied by a soundtrack in one particular language that is played over the system's main speakers, while a corresponding soundtrack in a different language is broadcast on a particular frequency to other listeners. In fact, many parallel soundtracks may be received or retrieved by the system as part of the same presentation stream (or collection of streams), then be delivered on different frequencies to wireless headset users, either independently or in connection with a visual presentation.

It should be noted that three-dimensional presentation and stereoscopic video can be generated by the system 10 using any of a variety of known techniques for such delivery. In one example embodiment, polarization of light emitted by projectors using filters, coupled with glasses having polarized lenses, delivers relatively inexpensive stereoscopic imagery to participants. In other embodiments, shuttered display and viewing yield an experience that does not depend on the tilt of the viewers' head, but relies on more expensive shuttering eyewear being worn by each viewer. Any other projection and viewing technologies may be used with this system as would occur to one skilled in the art.

In another embodiment, one or more high-bandwidth data network adapters are included with the system for receiving streaming data for display from remote sites. In one example of this embodiment, an Internet 2 connection provides available bandwidth of up to 100 megabits per second or more. Two (2) high-definition video streams and stereophonic audio can be carried over such connections with only modest compression (using, for example, H.264, VC-1, MPEG-2 or MPEG-4 video compression and AAC, MP3, DTS, or WMA audio compression, just to name a few examples). These streams, depending on the system's specifications, might use DVD, MMS, DTS, DVB, MPEG, AVI, OGM, MP4, UDP, or RTP transport protocols. Other codecs and transport formats will occur to those skilled in the art.

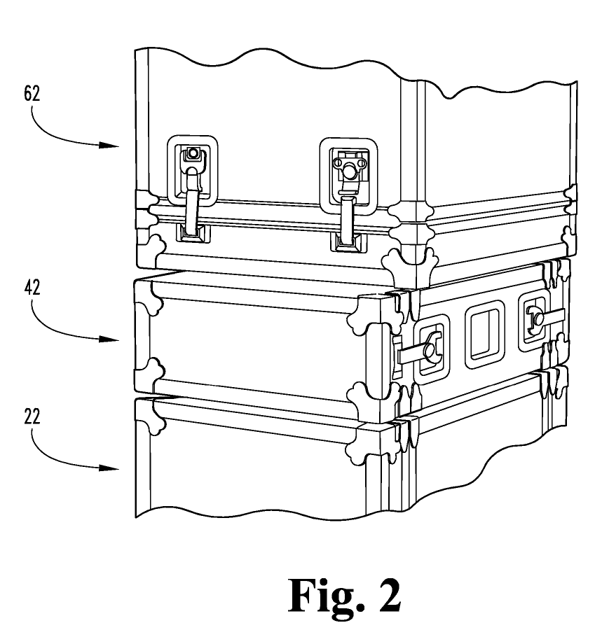

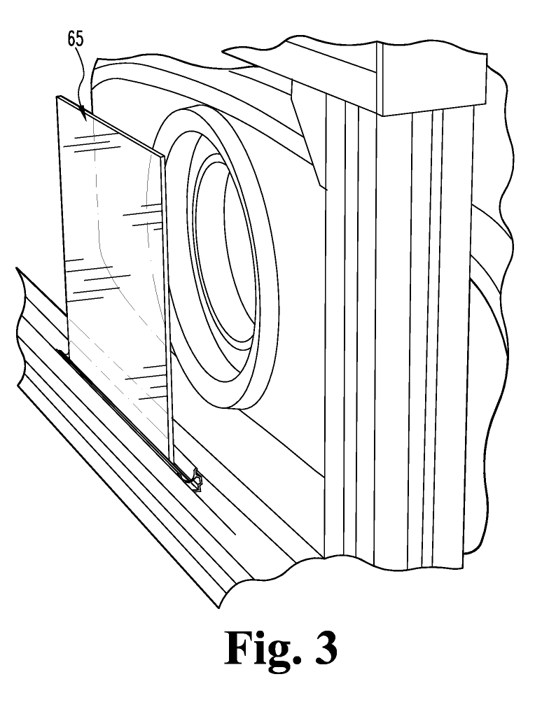

The physical form factor for the product preferably includes housing in readily transportable cases, such as are known for audio amplification components, as illustrated in FIG. 2. In one embodiment, the computing subsystem 20 is housed in one such case 22 equipped with casters on its bottom surface, while the audio subsystem 40 and display subsystem 60 each are housed in their own cases 42 and 62 respectively, for stacking on top of the computing subsystem case. The display subsystem case 62, when it contains projectors, may be fitted with an extruded aluminum framework that holds filters 65 for polarizing the output of projectors as illustrated in FIG. 3, as well as one or more motors (not shown) for moving the filters into and out of place in front of the projectors so that the system can automatically switch from mono- to stereoscopic presentation and back without manual user intervention.

In an alternative form factor, the system is installed in a single location, on one or more racks either of standard form or adapted for this use. The system's touchpad controller in these embodiments may be portable or fixed in location, and communicates with the other subsystems using wired or wireless techniques as will be understood in the art. Fixed installations might have fixed or removable screens, as well as distributed scent systems and transponders for multiple-screen output.

In other embodiments projectors are replaced by or supplemented by wired display technologies as will occur to those skilled in the art.

In yet other embodiments, audio/video capture technology is used to acquire mono- or stereoscopic video and polyphonic audio at a multimedia delivery site or in a network of such sites. One or more media streams are then sent through the computing subsystem's network interface to another site, which uses a system as described herein to decode and present the captured media to participants or viewers there.

In still other embodiments, a business provides a service of transporting one or more multimedia capture and/or display systems as described herein, establishing network connectivity, and operating the equipment for particular events, then disassembling the equipment for transport to another location or return to a main control location.

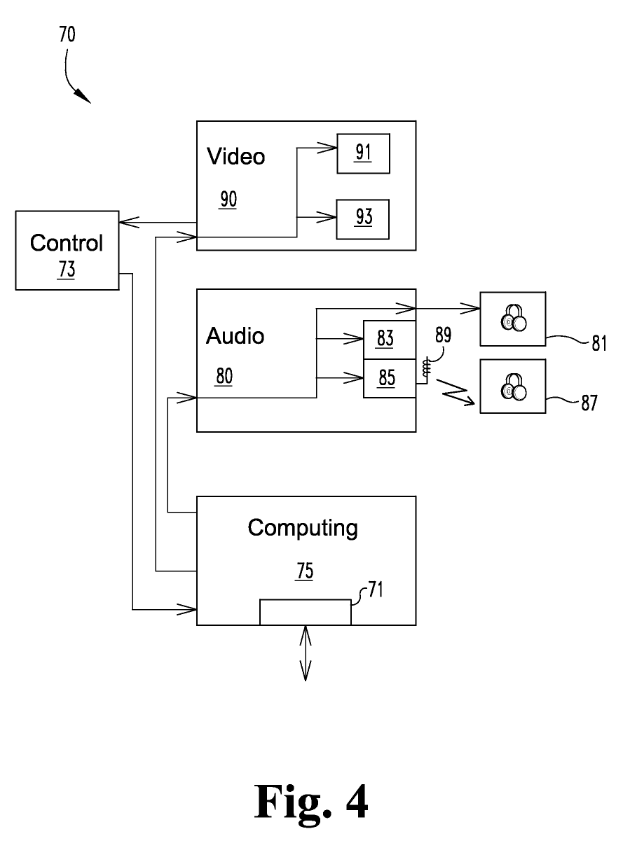

Turning now to FIG. 4, the block diagram illustrates system 70 in functional terms according to another embodiment. In this embodiment, the system 70 includes computing means 75, audio means 80, and video means 90. Network interface 71 operatively connects computing means 75 to other computing subsystems and other devices in a network that includes system 70. Audio output from computing means 75 passes through audio means 80 to wired headphones 81, speakers 83, and/or transceiver 85, which transmits audio to wireless headphones 87 via antenna 89 as described herein. Video output of system 70 passes through video means 90 to display means 91 and 93, which may provide one or more mono- or stereoscopic displays. Computing means 75 also generates the display for touch-screen controller 73, for which display data passes through the video means 90 as well.

In other embodiments (not shown), the display on control unit 73 is sent directly from computing means 75 to controller 73 using methods known in the art. User input to controller 73 is passed to computing means 75 using one or more wired or wireless connections as will be understood in the art. In still others, wireless handheld participant input/output pads communicate with computing means 75 via antenna 89 and audio means 80, while in yet others, wireless handheld participant input/output pads communicate with computing means 75 via an antenna that forms an integral part of computing means 75.

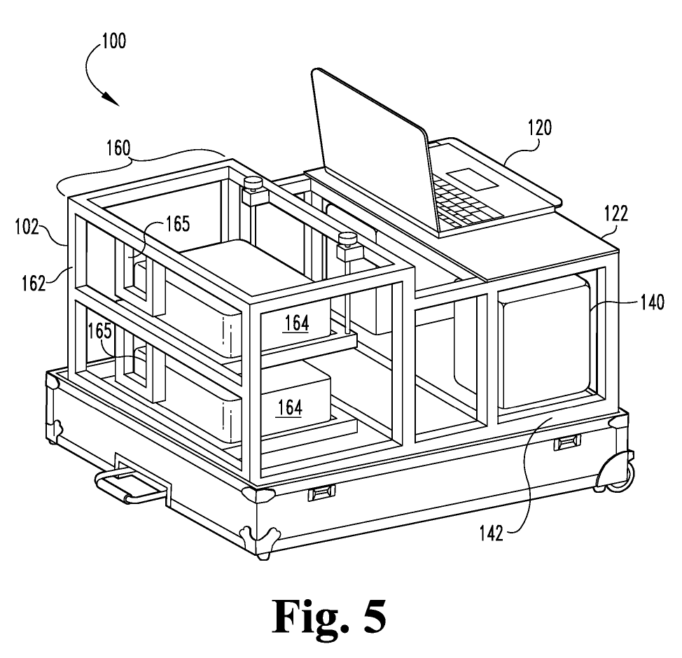

FIG. 5 illustrates a multimedia presentation system according to a second embodiment. In this embodiment, system 100 includes a computing subsystem 120, an audio subsystem 140, and a display subsystem 160. Display subsystem 160 includes two projectors 164 for stereoscopic display of video in a variety of environments. In variations of this embodiment, regions 165 include fixed or (manually or automatically) movable filters to enhance the projection as discussed above in relation to filters 65. Frame 102 supports system 100, which includes portions 122, 142, and 162 that are adapted to support and protect computing subsystem 120, audio subsystem 140, and display subsystem 160, respectively. Frame portions 122, 142, and 162 in some embodiments are rigidly connected to each other, while in other embodiments they are easily detachable. In some embodiments, one or more of the frame portions are fitted with carrying handles and/or castors, and in some embodiments outer panels or cases fit the frame portions to protect the equipment during movement of the subsystem(s) or the entire system.

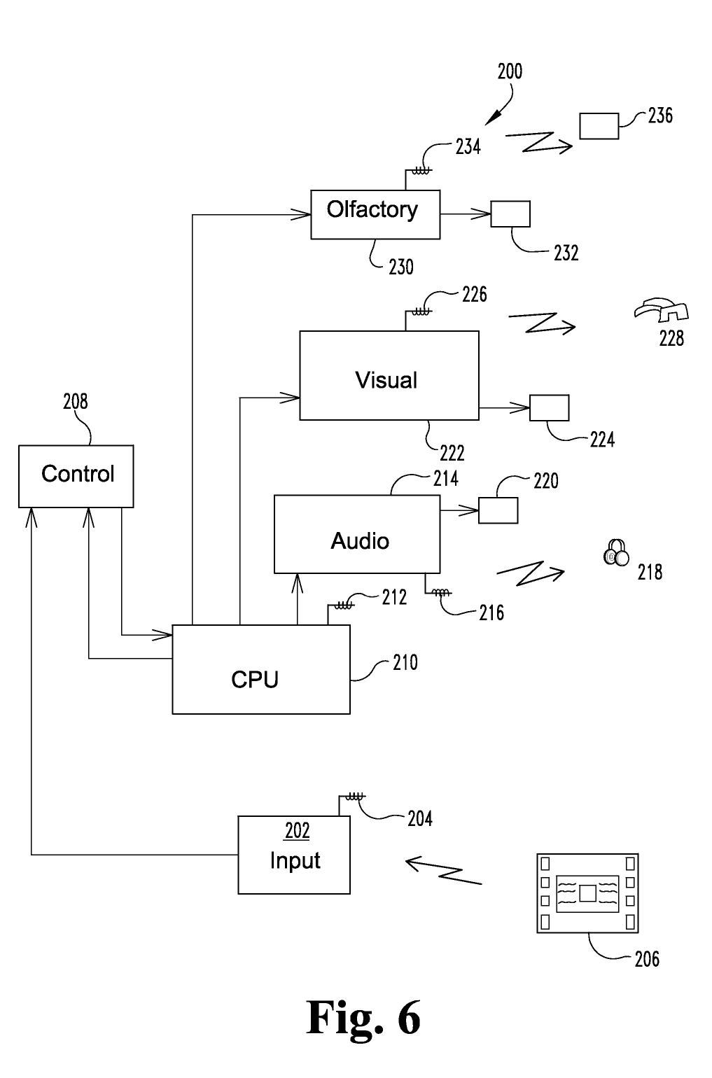

FIG. 6 shows a block diagram of yet another embodiment of a multimedia presentation system 200. In this particular embodiment, system 200 includes a computing means 210, an audio means 214, a video means 222, and an olfactory means 230. Computing means 210 can be monitored by a user through a control unit 208 such as a monitor or other display device. Optionally, control unit 208 may include input capabilities such as a touch screen or similar device in order to provide input for computing means 210. An input device 202 such a keyboard, mouse, touchpad, CD-ROM, DVD-ROM, USB port, or similar device is also included to provide input to computing means 210. Further, input device 202 may be accessible wirelessly through a wireless access device 204 such as an antenna, infrared sensor, or other suitable device, allowing one or more wireless control devices 206 to provide input to computing means 210. Optionally, computing means 210 may also include wireless access 212 allowing computing means 210 to access local wireless computer networks. Information input to computer means 210 may include data relating to audio, video, olfactory stimulation, and/or any combination thereof, as well as programming information concerning the timing and coordination or such data during a presentation. In alternative embodiments, computing means 210 further includes one or more removable data storage devices such as a hard drive or similar device.

An audio output signal from computing means 210 is directed towards audio unit 214. The audio signal is processed, amplified, and/or conditioned by audio unit 214 before being delivered to an output device 220 and/or to a wireless output 216. Output device 220 or 216 may include one or more speakers, a transceiver, or the like. Wireless output 216 may be configured so as to transmit an audio signal to one or more wireless headphone units 218, to an existing in-house sound system (not shown), or the like.

A video output signal from computing means 210 is directed towards video unit 222. The video signal is processed, modified, and or conditioned by video unit 222 before being delivered to output device 224 and/or to wireless output 226. Output device 224 may comprise one or more traditional or stereoscopic projectors that may include filters, polarizers, lenses, and the like, as desired. Wireless output 226 may be configured so as to transmit a video signal to one or more wireless video units 228 such as individual glasses, monitors, or display screens, or to an existing in-house video system or projector (not shown).

Information concerning scents is transmitted to an olfactory unit 230 by the computing means 210. The information concerning scents is processed, and essential oils, extracts, and the like are optionally combined to produce the desired odor and delivered to olfactory output device 232. Output device 232 may include fans, blowers, atomizers, and the like so as to deliver the desired scent at the appropriate time during a presentation. Optionally, olfactory unit 230 also includes a wireless output 226 which is capable of transmitting a signal to one or more remote olfactory devices 236.

In various embodiments, the systems described herein are transported as a collection of easily transportable subsystems/units, then are assembled at a venue in which the content is to be delivered. In some variations, connections between components are made using industry-standard cables, while in others the electrical connections between subsystems are achieved via a small number (one or two, for example) of easily identified, easily connected, ganged cables.

In some embodiments, the systems described herein are programmed with software to import presentations in standard document formats such as MS Word and MS PowerPoint, then replay them via the audio/video output system. In other embodiments, the system is sold as a kit, or even as a precalibrated system. In these embodiments, users are able to avoid compatibility issues between components, and in some situations might be able to achieve final, professional calibration of the system output without much of the extreme expense often associated with calibration of high-definition and/or stereoscopic video presentation systems.

In alternative embodiments, computing subsystem 20 includes a microcontroller or general purpose microprocessor that reads its program from a memory. Such a processor may be comprised of one or more components configured as a single unit. Alternatively, when of a multi-component form, the processor may have one or more components located remotely relative to the others. One or more components of the processor may be of the electronic variety defining digital circuitry, analog circuitry, or both. In one embodiment, the processor is of a conventional, integrated circuit microprocessor arrangement, such as one or more CORE 2 DUO processors from INTEL Corporation of 2200 Mission College Boulevard, Santa Clara, Calif., 95052, USA, or ATHLON or OPTERON processors from Advanced Micro Devices, One AMD Place, Sunnyvale, Calif., 94088, USA.

Various embodiments use different audio, video, and olfactory output devices such as LEDs, LCDs, plasma screens, front- or rear-projection displays, loudspeakers, amplifiers, or a combination of such devices, and other output devices and techniques could be used as would occur to one skilled in the art. Likewise, one or more input devices may include push-buttons, UARTs, IR and/or RF transmitters, receivers, transceivers, and/or decoders, or other devices, as well as traditional keyboard and mouse devices. In alternative embodiments, one or more application-specific integrated circuits (ASICs), general-purpose microprocessors, programmable logic arrays, or other devices may be used alone or in combination as would occur to one skilled in the art.

Likewise, in various embodiments, one or more memories used in or with the system include one or more types of solid-state electronic memory, magnetic memory, or optical memory, just to name a few. By way of non-limiting example, the memory can include solid-state electronic Random Access Memory (RAM), Sequentially Accessible Memory (SAM) (such as the First-In, First-Out (FIFO) variety or the Last-In First-Out (LIFO) variety), Programmable Read Only Memory (PROM), Electrically Programmable Read Only Memory (EPROM), or Electrically Erasable Programmable Read Only Memory (EEPROM); an optical disc memory (such as a recordable, rewritable, or read-only DVD or CD); a magnetically encoded hard disk, floppy disk, tape, or cartridge media; or a combination of any of these memory types. Also, the memory can be volatile, nonvolatile, or a hybrid combination of volatile and nonvolatile varieties.

While the disclosed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the disclosed technology are desired to be protected.

What is claimed is:

1. A multimedia presentation system adapted for use in educational settings, comprising:
a computing subsystem comprising a memory that stores a multimedia presentation, a communication system enabling the computing subsystem to wirelessly communicate with a computer network, and a processor, wherein the computing subsystem processes and distributes audio and video information contained in the multimedia presentation;
at least one wireless input unit configured to prompt a student to respond to inquiries and wirelessly transmit student responses to the computing subsystem;
a video subsystem comprising at least one video output device and capable of receiving, processing, and distributing video information provided by the computing subsystem; and
an audio subsystem comprising at least one audio output device and capable of receiving, processing, and distributing audio information provided by the computing subsystem;
wherein each of the at least one wireless input unit prompts a student to respond to inquiries concerning a multimedia presentation and transmits that response to the computing subsystem; and
wherein the computing subsystem adapts the output of the multimedia presentation in response to responses it receives from the at least one wireless input unit.

2. The multimedia presentation system of claim 1, wherein the inquiries concerning a multimedia presentation are designed to measure the student's comprehension of the subject matter of the multimedia presentation.

3. The multimedia presentation system of claim 2, wherein the computing subsystem receives input from a plurality of wireless input units comprising the responses of a plurality of students and adapts the output of the multimedia presentation in response thereto.

4. The multimedia presentation system of claim 1, wherein the video subsystem displays stereoscopic video.

5. The multimedia presentation system of claim 1, further comprising an olfactory subsystem comprising at least one olfactory output device that receives, processes, and distributes olfactory information provided by the computing subsystem;
wherein the computing subsystem receives input from the at least one wireless input unit and adapts the olfactory information in response thereto.

6. The multimedia presentation system of claim 5, wherein each of the computing subsystem, video subsystem, audio subsystem, and olfactory subsystem is a separable unit.

7. The multimedia presentation system of claim 6, further comprising carrying cases adapted and sized to hold each of the computing subsystem, video subsystem, audio subsystem, and olfactory subsystem.

8. The multimedia presentation system of claim 7, wherein the carrying cases are configured to form a support rack that holds the multimedia presentation system when in use.

9. A multimedia presentation system, comprising:
a computing subsystem comprising a memory for storing a multimedia presentation, a communication system that wirelessly communicates data between the computing subsystem and a computer network, and a processor, wherein the computing subsystem processes and distributes audio, video, and olfactory information contained in the multimedia presentation;
a video subsystem comprising at least one video output device and capable of receiving, processing, and distributing video information provided by the computing subsystem;
an audio subsystem comprising at least one audio output device and capable of receiving, processing, and distributing audio information provided by the computing subsystem; and
an olfactory subsystem comprising at least one olfactory output device and capable of receiving, processing, and distributing olfactory information provided by the computing subsystem.

10. The multimedia presentation system of claim 9, further comprising:
at least one wireless input unit configured to transmit user input to the computing subsystem;
wherein the computing subsystem receives input from the at least one wireless input unit and instructs the computing subsystem to adapt the output of one or more of the video, audio, and olfactory output devices in response thereto.

11. The multimedia presentation system of claim 9, wherein each of the computing subsystem, video subsystem, audio subsystem, and olfactory subsystem are separable units.

12. The multimedia presentation system of claim 11, further comprising carrying cases adapted and sized to hold each of the computing subsystem, video subsystem, audio subsystem, and olfactory subsystem.

13. The multimedia presentation system of claim 12, wherein the carrying cases are configurable to form a support rack that holds the multimedia presentation system when in use.

14. The multimedia presentation system of claim 9, wherein the video subsystem displays stereoscopic video.

15. The multimedia presentation system of claim 9, wherein the at least one audio output comprises headphones that are operably and wirelessly connected to the audio subsystem.
